(19) United States
(12) Patent Application Publication
(10) Pub. No.: US 2009/0097993 A1
(43) Pub. Date: Apr. 16, 2009

(54) Hermetic compressor

(75) Inventors: Young Ju Ryu, Gwangju-city (KR); Nam Hee Kang, Gwangju-city (KR)

Correspondence Address: OHLANDT, GREELEY, RUGGIERO & PERLE, LLP, ONE LANDMARK SQUARE, 10TH FLOOR, STAMFORD, CT, 06901, US

(73) Assignee: SAMSUNG GWANGJU ELECTRONICS CO., LTD., Gwangju-city (KR)

(21) Appl. No.: 11/989,022

(22) PCT Filed: Mar. 22, 2006
(86) PCT No.: PCT/KR2006/001036

§ 371 Date: Jan. 18, 2008

(30) Foreign Application Priority Data
Jul. 19, 2005 (KR) 10-2005-0065186
Jan. 3, 2006 (KR) 10-2006-0000702

(51) Int. Cl. F04B 17/03; H02K 33/16; H02K 11/00

(52) U.S. Cl. 417/410.1; 310/17; 310/71

(57) ABSTRACT

A hermetic compressor capable of insulating connectors (43), to which a plurality of lead lines (42) connected to a terminal block (41) and a plurality of stator coils (31a) used in a stator (31) are connected, without using a separate insulator, and capable of preventing defective insulation of the connectors due to vibration or friction during operation of the compressor. The hermetic compressor comprises a compression device (20) to compress a refrigerant, the stator constituting a drive device (30) to drive the compression device, the plurality of lead lines to apply electric power to the stator, the plurality of stator coils used in the stator, the plurality of connectors, one of the lead lines and one of the stator coils being connected to each connector, and an insulation member (50) having a plurality of seating recesses (52), in which the connectors are seated, respectively, and a plurality of fixing grooves (55), in which the lead lines are fixed, respectively.

### TECHNICAL FIELD

The present invention relates to a hermetic compressor, and, more particularly, to a hermetic compressor capable of insulating connectors, to which a plurality of lead lines connected to a terminal block that applies electric power from an external source and a plurality of stator coils used in a stator are connected, without using a separate insulator, and also capable of preventing defective insulation of the connectors due to vibration or friction during operation of the compressor.

### BACKGROUND ART

In general, a hermetic compressor includes a compression device arranged in a hermetic container, which defines a hermetic space therein, to compress a refrigerant, and a drive device to drive the compression device.

The drive device serves to generate a power required to reciprocate a piston of the compression device for allowing a refrigerant to be compressed in the compression device. The drive device includes a stator to produce a magnetic field, and a rotor radially spaced apart from an inner periphery of the stator to electromagnetically interact with the stator. Such a drive device itself acts as a single motor, and is driven when an electric power from an external source is applied thereto.

The stator of the drive device is formed of a plurality of stator coils wound on a core. The plurality of stator coils are connected to a plurality of lead lines connected to a terminal block, respectively, to receive an electric power from a terminal that is arranged at the hermetic container.

In a process to connect the plurality of stator coils, wound on the core, to the plurality of lead lines connected to the terminal block, respectively, it is essential to insulate connectors, to which the plurality of stator coils and the plurality of lead lines are connected, respectively. For this, the connectors must be covered with insulators, such as insulating tubes. This covering process, however, is very complex and troublesome.

Furthermore, there is a risk that the insulators may be peeled off or worn due to vibration caused during operation of the compressor or that the insulators may experience friction with other parts since the connectors are not at fixed positions. This inevitably results in defective insulation of the connectors.

### DISCLOSURE OF INVENTION

### Technical Problem

Therefore, the present invention has been made in order to solve the above problems, and it is an aspect of the invention to provide a hermetic compressor wherein a plurality of stator coils included in a stator can be easily connected with a plurality of lead lines connected to a terminal block by use of connectors while ensuring good insulation effect of the connectors.

It is another aspect of the invention to provide a hermetic compressor capable of preventing defective insulation of connectors due to vibration or friction during operation of the compressor by maintaining the connectors at fixed positions.

### Technical Solution

In accordance with one aspect, the present invention provides a hermetic compressor comprising: a compression device to compress a refrigerant; a stator constituting a drive device to drive the compression device; a plurality of lead lines to apply electric power to the stator; a plurality of stator coils used in the stator; a plurality of connectors, one of the lead lines and one of the stator coils being connected to each connector; and an insulation member having a plurality of seating recesses, in which the connectors are seated, respectively, and a plurality of fixing grooves, in which the lead lines are fixed, respectively.

Each of the lead lines and each of the stator coils may be coupled by use of a sleeve.

The sleeve may be inserted into and fixed in one of the seating recesses.

The insulation member may have an insert to be inserted into and fixed in an insertion space between adjacent insulator bulges of the stator.

The insert may have: a first holding portion to prevent horizontal motion of the insulation member; a supporting portion to support the first holding portion; and a second holding portion that is formed at a bottom of the supporting portion and adapted to prevent vertical motion of the insulation member.

The adjacent insulator bulges may be formed with bent portions, respectively, to limit horizontal motion of the first holding portion inserted into the insertion space and vertical motion of the second holding portion.

The insulation member may have a pair of binding wings which protrude outward from opposite lateral sides of the insulation member to be bound to the stator coil.

Both the binding wings may be formed with slippage-prevention jags to prevent the binding wings from sliding on and being separated from binders that are used to bind the binding wings to the stator coils.

Each of the fixing grooves may be formed at opposite longitudinal lateral sides thereof with downwardly inclined holding protrusions to prevent the lead line, inserted into the fixing groove, from being separated from the fixing groove.

### ADVANTAGEOUS EFFECTS

According to a hermetic compressor of the present invention, a plurality of connectors, to which a plurality of stator coils included in a stator and a plurality of lead lines connected to a terminal block that applies electric power are connected, respectively, are seated in seating recesses of an insulation member, respectively. This has the effect of maintaining insulation of the connectors without requiring a separate insulator.

Furthermore, according to the present invention, the connectors are securely fixed to the insulation member, and therefore, it is possible to prevent defective insulation of the connectors due to vibration or friction during operation of the compressor.

### DESCRIPTION OF DRAWINGS

The above and other objects, features and other advantages of the present invention will be more clearly understood from the following detailed description taken in conjunction with the accompanying drawings, in which:

FIG. 1 is a sectional view of a hermetic compressor according to an embodiment of the present invention;

FIG. 2 is a perspective view showing a sleeve, into which a stator coil and a lead line are connected;

FIG. 3 is a perspective view showing a terminal block connected to a stator;

FIG. 4 is a perspective view showing an insulation member on which a connector for both the stator coil and the lead line will be seated;

FIG. 5 is a perspective view showing an insert of FIG. 4 prior to being inserted into an insertion space between insulator bulges;

FIG. 6 is a plan view showing an insert of FIG. 4 after being inserted and fixed between insulator bulges of the stator;

FIG. 7 is an enlarged view illustrating the circle A of FIG. 6; and

FIG. 8 is a longitudinal sectional view showing the connector for both the stator coil and the lead line, which is inserted into and seated in a seating recess of the insulation member.

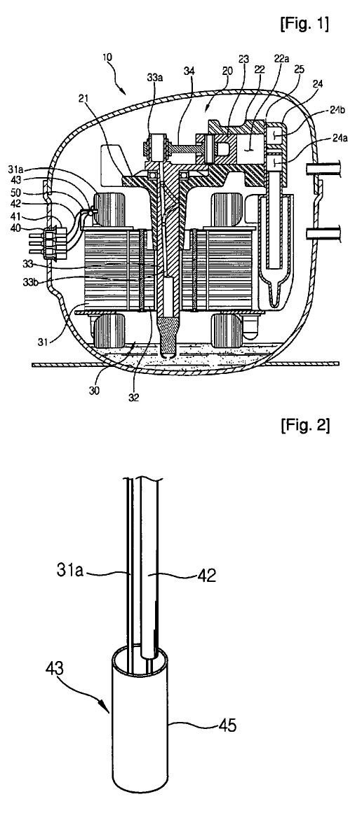

### MODE FOR INVENTION

Reference will now be made in detail to a hermetic compressor according to a preferred embodiment of the present invention. The embodiment is described below to explain the present invention by referring to the figures.

The hermetic compressor according to the preferred embodiment of the present invention includes a compression device 20 arranged in a hermetic container 10, which defines a hermetic space, to compress a refrigerant, and a drive device 30 to drive the compression device 20.

The compression device 20 includes a frame 21, a cylinder block 22, a piston 23, a cylinder head 24, and a valve device 25. The cylinder block 22 is integrally formed with the frame 21 and has a compression chamber 22a defined therein. The piston 23 is adapted to reciprocate in the compression chamber 22a to compress a refrigerant. The cylinder head 24 is coupled to a side of the cylinder block 22 and has a suction chamber 24a and a discharge chamber 24b, which communicate with the outside. The valve device 25 is interposed between the cylinder block 22 and the cylinder head 24 to control introduction/discharge of the refrigerant.

The drive device 30 serves to reciprocate the piston 23 for allowing the refrigerant to be compressed in the compression device 20. The drive device 30 includes a stator 31 to produce a magnetic field, and a rotor 32 radially spaced apart from an inner periphery of the stator 31 to electromagnetically interact with the stator 31. A rotary shaft 33 is press fitted in the center of the rotor 32 to rotate along with the rotor 32 within the frame 21. At an upper end of the rotary shaft 33 is formed an eccentric shaft 33a. The eccentric shaft 33a is connected to a connecting rod 34, which is coupled at one end thereof to the piston 23 to convert rotating motion into linear motion.

The rotary shaft 33 has an elongated oil flow path 33b axially extending therein, so that oil stored in a bottom region of the hermetic container 10 is suctioned and injected to the compression device 20 above the rotary shaft 33 by passing through the oil flow path 33b.

If electric current is applied to the hermetic compressor having the above described configuration, the stator produces a magnetic field, thereby causing the rotor 32 to rotate while electromagnetically interacting with the stator 31. Simultaneously with the rotation of the rotor 32, the rotary shaft 33 rotates. Then, such rotating motion of the rotary shaft 33 is converted into linear reciprocating motion of the piston 23 via the eccentric shaft 33a and the connecting rod 34, which are arranged above the rotary shaft 33, thereby allowing the piston 23 to compress a refrigerant within the compression chamber 22a.

The hermetic container 10 is provided with a terminal 40, which is connected to an external power source to apply electric current to the stator 31. The terminal 40 is coupled with a terminal block 41 arranged in the hermetic container 10. Also, a plurality of lead lines 42 are extended from the terminal block 41 that is coupled with the terminal 40. The plurality of lead lines 42 are connected to a plurality of stator coils 31a included in the stator 31, respectively, to apply electric current to the stator 31. In this case, a plurality of connectors 43 are provided in such a fashion that one of the lead lines 42 and one of the stator coils 31a are connected to each connector 43. The plurality of connectors 43 are seated in an insulation member 50.

Referring to FIG. 2, the connector 43, to which the lead line 42 and the stator coil 31a are connected, is fabricated by inserting the lead line 42 that is extended from the terminal block 41 and the stator coil 31a that is used in the stator 31 into a cylindrical sleeve 45, and pressing a part of the sleeve 45 by use of a press.

Referring to FIG. 3, the stator 31 includes a core 31b, and the plurality of stator coils 31a are wound on the core 31b.

The plurality of stator coils 31a are arranged on an inner peripheral portion of the core 31b so that they are wound via slots 36, which are defined between respective insulator bulges 35 that are used to insulate the stator coils 31a. After being wound, the stator coils 31b are bound by use of binders 37. The connectors 43 are seated on and fixed to the insulation member 50 after the stator coils 31a, wound on the core 31b, and the lead lines 42 are connected to the connectors 43.

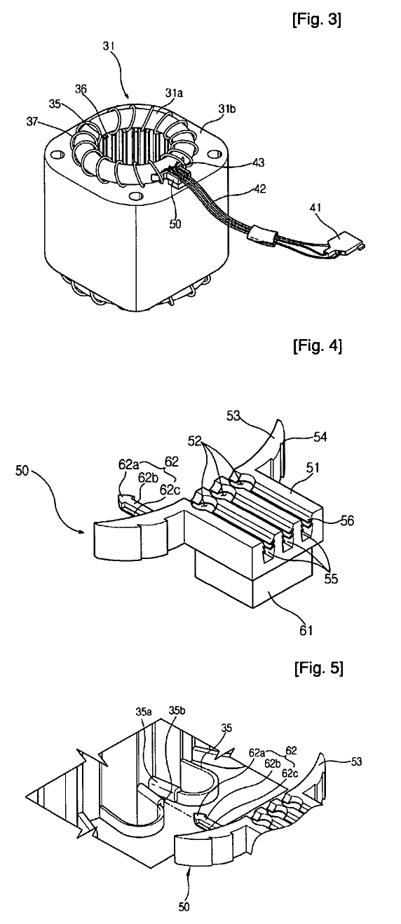

Referring to FIG. 4, the insulation member 50, to which the connectors 43 are seated and fixed, includes an upper body 51, and a supporting base 61 located beneath the upper body 51 to support the body 51. The insulator member 50 is made of an electric insulator, such as plastics.

The body 51 is formed with a plurality of seating recesses 52 in which the connectors 43 are seated, respectively, and with a plurality of fixing grooves 55 in which the lead lines 42 are fixed, respectively.

The body 51 is also formed with binding wings 53, which protrude outward from opposite lateral sides of the body 51. The binding wings 53 are bound to the uppermost stator coil 31a, which is wound on the top of the core 31b in a doughnut form, by use of the binders 37. To prevent the binding wings 53 from sliding on and being unintentionally separated from the binders 37 that bind the binding wings 53 to the stator coils 31a, the binding wings 53 are formed with a plurality of slippage-prevention jags 54 at portions where come into contact with the binders 37. The binding wings 53 are curved in a bow shape with the same curvature as that of an outer periphery of the uppermost doughnut shaped stator coil 31a, to come into close contact with the outer periphery of the stator coil 31a.

Preferably, the seating recesses 52 each has an inner diameter equal to an outer diameter of the sleeves 45 so that the cylindrical sleeves 45, which are used to connect the stator coils 31a with the lead lines 42, can be seated and fixed in the seating recesses 52, respectively, without a risk of separation.

Each of the fixing grooves 55, which communicates at one end thereof with one of the seating recess 52, is longitudinally formed along opposite lateral sides thereof with downwardly inclined holding protrusions 56, to facilitate the insertion of the lead line 42 and to prevent separation of the lead line 42 after the lead line 42 is inserted into the fixing groove 55.

The base 61, which used to support the body 51, is formed with an insert 62. The insert 62 extends from the base 61 toward the stator coils 31a, so that it is inserted into and fixed between adjacent ones of the insulator bulges 35 to electrically insulate the respective stator coils 31a.

The insert 62 has a first holding portion 62a that is configured to be inserted into and caught by the adjacent insulator bulges 35 and adapted to prevent horizontal motion of the insulation member 50, a supporting portion 62b to support the first holding portion 62a, and a second holding portion 62c that is formed at the bottom of the supporting portion 62b and adapted to prevent vertical motion of the insulation member 50. A distal end of the first holding portion 62a has a pointed spade shape suitable to be easily inserted between the adjacent insulator bulges 35.

FIG. 5 shows the configuration of the insulator bulges 35 for the insertion of the insert 62 of the insulation member 50. As shown in FIG. 5, in the case of the adjacent two insulator bulges 35 for allowing the insert 62 to be inserted therebetween, facing lateral portions of the two insulator bulges 35 are downwardly bent to form bent portions 35a such that an insertion space 35b for the insertion of the insert 62 of the insulation member 50 is defined between the bent portions 35a of the adjacent insulator bulges 35.

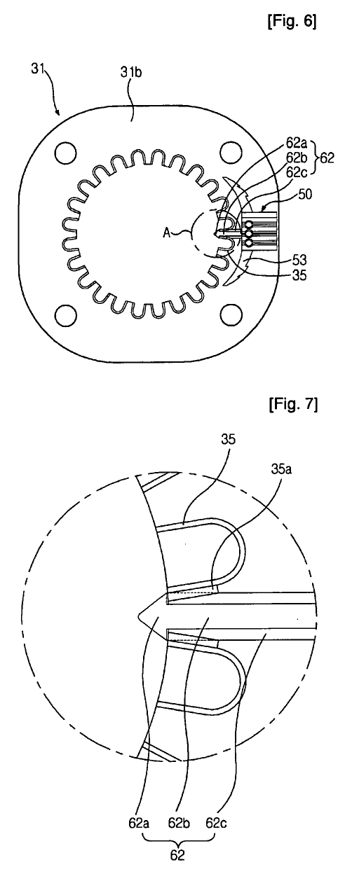

FIG. 6 and FIG. 7, which is an enlarged view of the circle A of FIG. 6, illustrate the insert 62 of the insulation member 50 after being inserted into and fixed in the insertion space 35b between the insulator bulges 35. The insulator bulges 35 are mainly made of plastics, and thus, have an elasticity sufficient to be outwardly bent. Thereby, if the insulation member 50 is pushed in a radial direction of the stator 31 in a state wherein the insert 62 is located in the insertion space 35b between the insulator bulges 35, the first holding portion 62a is inserted into the insertion space 35b to widen between the insulator bulges 35. After that, if the insulation member 50 is continuously pushed until the second holding portion 62c is located between the insulator bulges 35, the insulator bulges 35 are elastically restored to thereby press opposite lateral sides of the second holding portion 62c.

In this case, the first holding portion 62a of the insert 62 is limited in horizontal motion by the bent portions 35a of the insulator bulges 35, and the second holding portion 62c of the insert 62 is limited in vertical motion by the bent portions 35a of the insulator bulges 35.

With this configuration, a lower portion of the insulation member 50 is fixed to the insulator bulges 35 as the insert 62 is inserted between the insulator bulges 35, and an upper portion of the insulation member 50 is fixed to the stator coils 31a as the binding wings 53 are bound to the stator coils 31a by use of the binders 37. As a result, the insulation member 50 is entirely fixed to the stator 31.

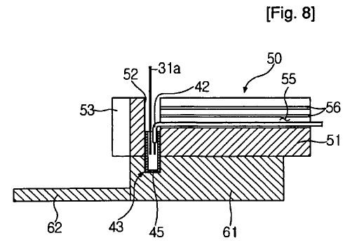

FIG. 8 shows one of the sleeves 45 seated on and fixed to the insulation member 50 after one of the lead lines 42 and one of the stator coil 42 are connected to the sleeve 45.

First, the sleeve 45 is seated in one of the seating recesses 52. Then, the lead line 42, connected to the sleeve 45, is bent to be inserted into one of the fixing grooves 55. After being inserted into the fixing groove 55, the lead line 42 can be securely fixed by the holding protrusions 56 so as not to be separated from the fixing groove 55.

As stated above, as a result of seating the plurality of connectors 43, to which the plurality of stator coils 31a and the plurality of lead lines 42 are connected respectively, in the respective seating recesses 52 formed at the insulation member 50, and insulating between the seating recesses 52 with the electrical insulator bulges 35, it is possible to easily achieve insulation between the connectors 43. Also, since the connectors 43 can be easily fabricated by use of the sleeves 45, an overall manufacturing process is simplified.

### INDUSTRIAL APPLICABILITY

As apparent from the above description, the present invention provides a hermetic compressor wherein a plurality of connectors, to which a plurality of stator coils included in a stator and a plurality of lead lines connected to a terminal block that applies electric power are connected, respectively, are seated in seating recesses of an insulation member, respectively, whereby insulation of the connectors can be maintained without requiring a separate insulator.

Furthermore, according to the present invention, since the connectors are securely fixed to the insulation member, it is possible to prevent defective insulation of the connectors due to vibration or friction during operation of the compressor.

Although embodiments of the present invention have been shown and described, it would be appreciated by those skilled in the art that changes may be made in this embodiment without departing from the principles and spirit of the invention, the scope of which is defined in the claims and their equivalents.

1. A hermetic compressor comprising:
a compression device to compress a refrigerant;
a stator constituting a drive device to drive the compression device;
a plurality of lead lines to apply electric power to the stator;
a plurality of stator coils used in the stator;
a plurality of connectors, one of the lead lines and one of the stator coils being connected to each connector; and
an insulation member having a plurality of seating recesses, in which the connectors are seated, respectively, and a plurality of fixing grooves, in which the lead lines are fixed, respectively.

2. The apparatus as set forth in claim 1, wherein each of the lead lines and each of the stator coils are coupled by use of a sleeve.

3. The apparatus as set forth in claim 2, wherein the sleeve is inserted into and fixed in one of the seating recesses.

4. The apparatus as set forth in claim 1, wherein the insulation member has an insert to be inserted into and fixed in an insertion space between adjacent insulator bulges of the stator.

5. The apparatus as set forth in claim 4, wherein the insert has:
a first holding portion to prevent horizontal motion of the insulation member;
a supporting portion to support the first holding portion; and
a second holding portion that is formed at a bottom of the supporting portion and adapted to prevent vertical motion of the insulation member.

6. The apparatus as set forth in claim 5, wherein the adjacent insulator bulges are formed with bent portions, respectively, to limit horizontal motion of the first holding portion inserted into the insertion space and vertical motion of the second holding portion.

7. The apparatus as set forth in claim 1, wherein the insulation member has a pair of binding wings which protrude outward from opposite lateral sides of the insulation member to be bound to the stator coil.

8. The apparatus as set forth in claim 7, wherein both the binding wings are formed with slippage-prevention jags to prevent the binding wings from sliding on and being separated from binders that are used to bind the binding wings to the stator coils.

9. The apparatus as set forth in claim 1, wherein each of the fixing grooves is formed at opposite longitudinal lateral sides thereof with downwardly inclined holding protrusions to prevent the lead line, inserted into the fixing groove, from being separated from the fixing groove.
